(19) United States
(12) Patent Application Publication
(10) Pub. No.: US 2025/0015381 A1
(43) Pub. Date: Jan. 9, 2025

(54) TRACTION BATTERY PACK THERMAL MANAGEMENT SYSTEMS THAT PROVIDE BOTH PRIMARY AND SECONDARY COOLING PATHS

(71) Applicant: FORD GLOBAL TECHNOLOGIES, LLC, Dearborn, MI (US)

(72) Inventor: Xiaogang ZHANG, Novi, MI (US)

(21) Appl. No.: 18/346,312

(22) Filed: Jul. 3, 2023

(51) Int. Cl. H01M 10/625; B60L 50/64; H01M 10/613; H01M 10/6561; H01M 10/6567; H01M 50/209; H01M 50/271; H01M 50/289

(52) U.S. Cl. CPC H01M 10/625; B60L 50/64; H01M 10/613; H01M 10/6561; H01M 10/6567; H01M 50/209; H01M 50/271; H01M 50/289; H01M 2220/20

(57) ABSTRACT

Thermal management systems are provided for traction battery packs. An exemplary thermal management system may include a primary cooling system configured for directing a first cooling fluid through a first interior volume of one or more battery modules, and a secondary cooling system configured for directing a second cooling fluid through a second interior volume of an enclosure assembly that houses the one or more battery modules. The primary cooling system may establish a primary cooling path for thermally managing battery cells of the one or more battery modules, and the secondary cooling system may establish a secondary cooling path for thermally managing a terminal and/or a busbar of the one or more battery modules.

### TECHNICAL FIELD

This disclosure relates generally to electrified vehicle traction battery packs, and more particularly to thermal management systems for traction battery packs.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, an enclosure assembly, a plurality of battery modules housed within the enclosure assembly, a primary cooling system configured for directing a first cooling fluid through a first interior volume of each of the plurality of battery modules, and a secondary cooling system configured for directing a second cooling fluid through a second interior volume of the enclosure assembly.

In a further non-limiting embodiment of the foregoing traction battery pack, each of the plurality of battery modules includes a battery subassembly and an outer cover.

In a further non-limiting embodiment of either of the foregoing traction battery packs, the battery subassembly includes a plurality of battery cells held between a first frame and a second frame.

In a further non-limiting embodiment of any of the foregoing traction battery packs, adjacent battery cells of the plurality of battery cells are at least partially separated by a sealing bar of the first frame and the second frame.

In a further non-limiting embodiment of any of the foregoing traction battery packs, the outer cover includes four sides and two open ends.

In a further non-limiting embodiment of any of the foregoing traction battery packs, the first frame is positioned at one of the two open ends of the outer cover, and the second frame is positioned at another of the two open ends.

In a further non-limiting embodiment of any of the foregoing traction battery packs, the first cooling fluid cools the plurality of battery cells, and the second cooling fluid cools a busbar or a terminal located external to the first interior volume.

In a further non-limiting embodiment of any of the foregoing traction battery packs, the first cooling fluid cools at least one battery cell of each of the plurality of battery modules, and the second cooling fluid cools a busbar or a terminal of each of the plurality of battery modules.

In a further non-limiting embodiment of any of the foregoing traction battery packs, the primary cooling system includes an inlet pipe, a delivering line fluidly connected to the inlet pipe and to an inlet tube of at least one of the plurality of battery modules, an outlet pipe, and a receiving line fluidly connect to an outlet tube of the at least one of the plurality of battery modules and the outlet pipe.

In a further non-limiting embodiment of any of the foregoing traction battery packs, the first interior volume is located between the inlet tube and the outlet tube.

In a further non-limiting embodiment of any of the foregoing traction battery packs, the secondary cooling system includes an inlet tube mounted to a first end wall of the enclosure assembly, and an outlet tube mounted to a second end wall of the enclosure assembly. The second interior volume is located between the inlet tube and the outlet tube.

In a further non-limiting embodiment of any of the foregoing traction battery packs, the first cooling fluid is a coolant, and the second cooling fluid is an airflow or a dielectric fluid.

A traction battery pack according to another exemplary aspect of the present disclosure includes, among other things, a battery module including a battery cell, a terminal, and a busbar. A thermal management system establishes a primary cooling path for thermally managing the battery cell and a secondary cooling path for thermally managing the terminal and the busbar.

In a further non-limiting embodiment of the foregoing traction battery pack, the primary cooling path extends through an interior volume of the battery module.

In a further non-limiting embodiment of either of the foregoing traction battery packs, the primary cooling path extends between the battery cell and a second battery cell and further between the battery cell and an outer cover of the battery module.

In a further non-limiting embodiment of any of the foregoing traction battery packs, a sealing bar of a frame of the battery module at least partially separates the battery cell from the second battery cell.

In a further non-limiting embodiment of any of the foregoing traction battery packs, the secondary cooling path extends through an interior volume of an enclosure assembly that houses the battery module.

In a further non-limiting embodiment of any of the foregoing traction battery packs, the primary cooling path is configured to circulate a first cooling fluid through portions of an inlet pipe, a delivering line fluidly connected to the inlet pipe, an inlet tube of the battery module that is fluidly connected to the delivering line, an interior volume of the battery module, an outlet tube of the battery module, a receiving line fluidly connected to the outlet tube, and an outlet pipe fluidly connected to the receiving line.

In a further non-limiting embodiment of any of the foregoing traction battery packs, the secondary cooling path is configured to circulate a second cooling fluid through a channel located between the battery module and a second battery module.

In a further non-limiting embodiment of any of the foregoing traction battery packs, the second cooling fluid includes a dielectric fluid or an airflow.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack that includes a thermal management system.

FIG. 3 illustrates an exemplary battery module of the traction battery pack of FIG. 2.

FIG. 4 is an exploded view of the battery module of FIG. 3.

FIG. 5 is a cross-sectional view of the battery module of FIG. 3 and schematically illustrates a primary cooling path of a traction battery pack thermal management system.

FIG. 6 schematically illustrates a secondary cooling path of a traction battery pack thermal management system.

### DETAILED DESCRIPTION

This disclosure details thermal management systems for traction battery packs. An exemplary thermal management system may include a primary cooling system configured for directing a first cooling fluid through a first interior volume of one or more battery modules, and a secondary cooling system configured for directing a second cooling fluid through a second interior volume of an enclosure assembly that houses the one or more battery modules. The primary cooling system may establish a primary cooling path for thermally managing battery cells of the one or more battery modules, and the secondary cooling system may establish a secondary cooling path for thermally managing a terminal and/or a busbar of the one or more battery modules. These and other features are discussed in greater detail in the following paragraphs of this detailed description.

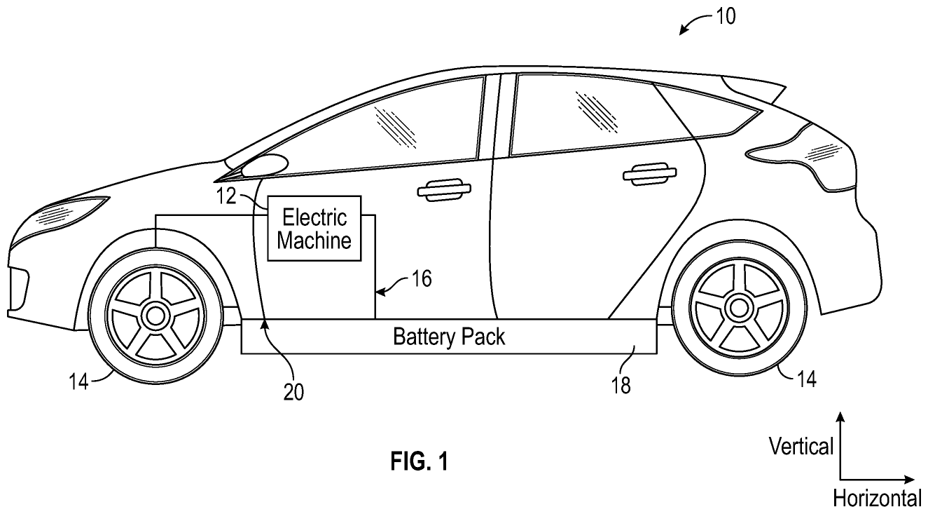

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

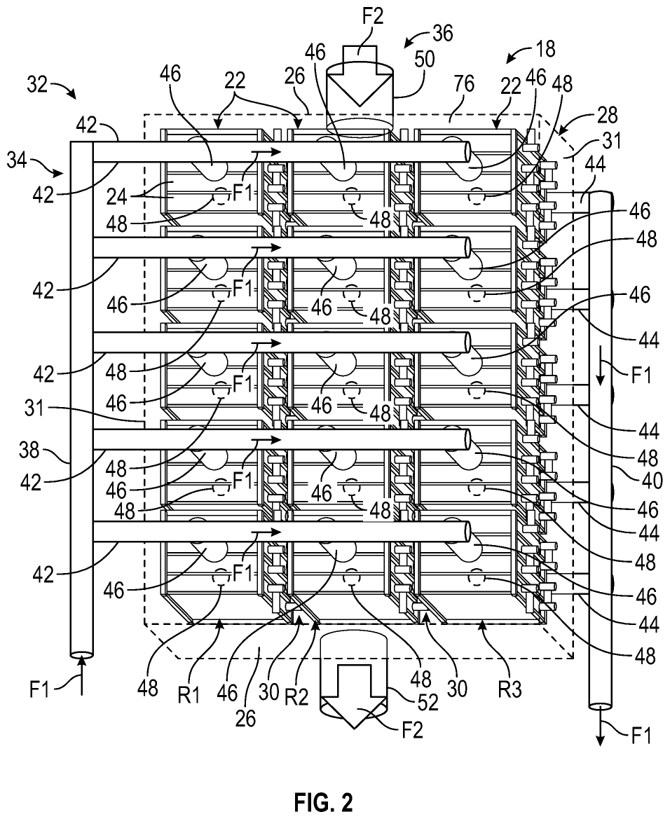

FIG. 2 illustrates additional details associated with the traction battery pack 18 of the electrified vehicle 10 of FIG. 1. The traction battery pack 18 may include a plurality of battery modules 22 (e.g., battery assemblies or groupings of rechargeable battery cells 24) capable of outputting electrical power to power the electric machine 12 and/or other electrical loads of the electrified vehicle 10.

The battery cells 24 may be stacked side-by-side along a stack axis to construct a grouping of battery cells 24, sometimes referred to as a “cell stack.” The total number of battery modules 22 and battery cells 24 provided within the traction battery pack 18 is not intended to limit this disclosure.

In an embodiment, the battery cells 24 of each battery module 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery modules 22 may be arranged in multiple rows inside the traction battery pack 18. For example, the battery modules 22 could be arranged in a first row R1, a second row R2 that is laterally adjacent to the first row R1, and a third row R3 that is laterally adjacent to the second row R2. In an embodiment, each of the first row R1, the second row R2, and the third row R3 includes five battery modules 22 (for a total of fifteen battery modules 22), and each battery module 22 includes four battery cells 24 (for a total of sixty battery cells 24). However, other configurations are possible, and therefore the traction battery pack 18 could include a greater or fewer number of rows, battery modules, and battery cells within the scope of this disclosure.

The battery modules 22 and various other battery internal components (e.g., bussed electrical center, battery electric control module, wiring, connectors, etc.) may be housed inside of an enclosure assembly 28 of the traction battery pack 18. Although shown schematically, the enclosure assembly 28 could embody a single-piece design or multi-piece design (e.g., enclosure cover and enclosure tray that are joined together to establish an interior for housing the battery modules 22). The size, shape, and overall configuration of the enclosure assembly 28 is not intended to limit this disclosure. In an embodiment, the enclosure assembly 28 provides a sealed enclosure around the battery modules 22 and other battery internal components of the traction battery pack 18.

Each battery module 22 may be completely separated from the other battery modules 22 of the traction battery pack 18. For example, the battery modules 22 may be spaced apart from one another within each of the first row R1, the second row R2, the third row R3. Furthermore, a channel 30 may extend between the first row R1 and the second row R2 and between the second row R2 and the third row R3 for separating the battery modules 22 of each respective row. The channels 30 may extend longitudinally between opposing end walls 26 of the enclosure assembly 28. Side walls 31 of the enclosure assembly 28 connect between the end walls 26.

The traction battery pack 18 may additionally include a thermal management system 32. As further explained below, the thermal management system 32 may establish both primary and secondary cooling paths for thermally managing the battery modules 22 and/or other electrical components of the traction battery pack 18.

The thermal management system 32 may include a primary cooling system 34 and a secondary cooling system 36. The primary cooling system 34 may be configured for cooling individual surfaces of the battery cells 24 by introducing a first cooling fluid F1 into each battery module 22, and the secondary cooling system 36 may be configured for cooling components that are at least partially external to the battery modules 22 (e.g., terminals, busbars, etc.) by introducing a second cooling fluid F2 into the enclosure assembly 28 of the traction battery pack 18.

The primary cooling system 34 may include an inlet pipe 38, an outlet pipe 40, a plurality of delivering lines 42, and a plurality of receiving lines 44. The inlet pipe 38 and the outlet pipe 40 may extend outside the enclosure assembly 28, and at least a portion of the delivering lines 42 and the receiving lines 44 may extend through the interior of the enclosure assembly 28. The delivering lines 42 may be fluidly connected to the inlet pipe 38, and the receiving lines 44 may be fluidly connected to the outlet pipe 40. Each delivering line 42 may also be fluidly connected to an inlet tube 46 of one or more of the battery modules 22, and each receiving line 44 may also be fluidly connected to an outlet tube 48 of one or more of the battery modules 22.

The primary cooling system 34 may be configured to communicate the first cooling fluid F1 for managing the heat generated by the battery cells 24 of the battery modules 22 during operation of the traction battery pack 18. In an embodiment, the first cooling fluid F1 is conventional type of coolant mixture such as water mixed with ethylene glycol. However, other coolants, including gases, are also contemplated within the scope of this disclosure.

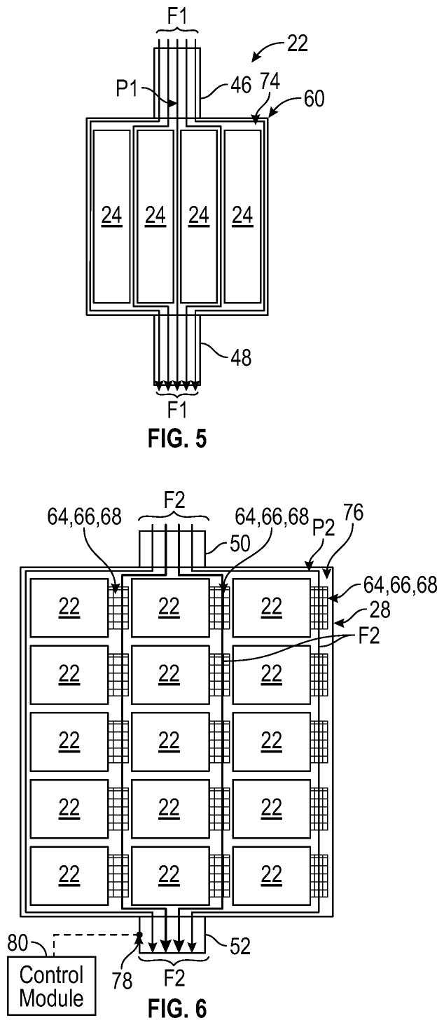

The inlet pipe 38 may be fluidly connected to a fluid source (not shown) that stores the first cooling fluid F1. The fluid source could be part of a main cooling system of the electrified vehicle 10 or could be a dedicated fluid source of the traction battery pack 18. The first cooling fluid F1 may be communicated through the inlet pipe 38 before being separated into the multiple delivering lines 42. The first cooling fluid F1 may then enter an interior volume (see, for example, reference numeral 74 of FIG. 5) of each battery module 22 through the inlet tubes 46. The first cooling fluid F1 may pick up heat from the battery cells 24 as it flows through the interior volume of each battery modules 22, thereby carrying away excessive heat and stabilizing the temperatures of the battery cells 24.

The first cooling fluid F1 may exit through the outlet tubes 48 of each battery module 22 and then enter the receiving lines 44 before merging into the outlet pipe 40, which it can them be expelled from the traction battery pack 18. The first cooling fluid F1 may be returned to the fluid source as part of a closed loop system via the outlet pipe 40. Although not shown, the first cooling fluid F1 may be delivered to a radiator or some other heat exchanging device for cooling before being returned to the fluid source.

The secondary cooling system 36 may include an inlet tube 50 and an outlet tube 52. The inlet tube 50 and the outlet tube 52 may each be mounted to the enclosure assembly 28 of the traction battery pack 18. For example, the inlet tube 50 may be mounted to one of the end walls 26, and the outlet tube 52 may be mounted to another one of the end walls 26 of the enclosure assembly 28. However, other configurations are contemplated within the scope of this disclosure.

The secondary cooling system 36 may be configured to communicate the second cooling fluid F2 through an interior volume 76 (see FIGS. 2 and 6) of the enclosure assembly 28 for managing heat generated by certain components of the traction battery pack 18. In an embodiment, the second cooling fluid F2 is airflow or a dielectric fluid. The second cooling fluid F2 may enter into the interior volume 76 of the enclosure assembly 28 through the inlet tube 50. The second cooling fluid F2 may then circulate through various open spaces of the interior volume 76 prior to being expelled from the traction battery pack 18 through the outlet tube 52. For example, the second cooling fluid F2 may flow through each of the channels 30, through an open space between the side wall 31 and the first row R1 of the battery modules 22, through another open space between the side wall 31 and the third row R3 of the battery modules 22, etc. for managing heat generated within the traction battery pack 18.

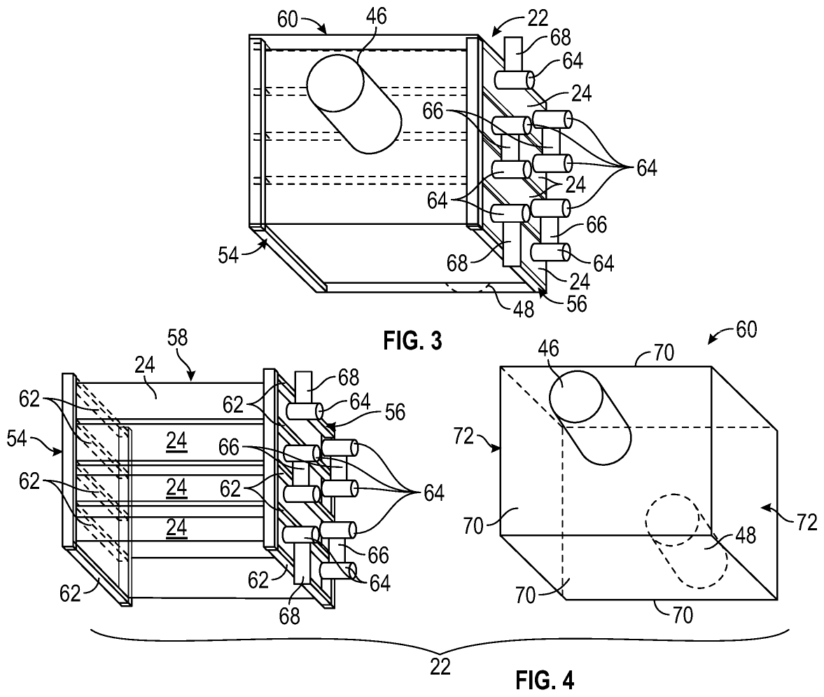

FIGS. 3, 4, and 5 illustrate an exemplary design of a battery module 22 of the traction battery pack 18 of FIGS. 1 and 2. Each battery module 22 of the traction battery pack 18 may include an identical design to the battery module 22 shown in FIGS. 3, 4, and 5, or a similar design as its electrical connections with neighboring battery modules can vary in order to completely a necessary electrical circuit of the traction battery pack 18.

The battery module 22 may include a plurality of battery cells 24 stacked between a first frame 54 and a second frame 56. Together, the battery cells 24, the first frame 54, and the second frame 56 may establish a battery subassembly 58 (best shown in FIG. 4). The battery subassembly 58 may be received within an outer cover 60 to establish the battery module 22.

The battery cells 24 may be held together in a desired position relative to one another by the first frame 54 and the second frame 56. The first frame 54 and the second frame 56 may each include a plurality of sealing bars 62 that at least partially separate the battery cells 24 of the battery subassembly 58 from one another. The sealing bars 62 may be configured to exert a relatively small amount of compression upon the battery cells 24 in order to maintain their positions within the battery module 22.

In an embodiment, the first frame 54 and the second frame 56 are constructed from a high temperature polymer and are square-shaped. However, other materials and shapes are contemplated within the scope of this disclosure.

Each battery cell 24 may include a pair of terminals 64. The terminals 64 of adjacent battery cells 24 may be connected by internal busbars 66 in order to electrically connect the battery cells 24 of the battery subassembly 58. External busbars 68 may be provided for electrically connecting the battery subassembly 58 of the battery module 22 to adjacent battery modules of the traction battery pack 18.

The terminals 64, the internal busbars 66, and the external busbars 68 may be arranged at a common side of the battery subassembly 58. Thus, in the exemplary embodiment, the terminals 64, the internal busbars 66, and the external busbars 68 are all arranged adjacent to the second frame 56. However, other configurations are contemplated within the scope of this disclosure.

The outer cover 60 may be configured as a sleeve that includes four sides 70 and two open ends 72. The battery subassembly 58 may be inserted into the outer cover 60 such that the first frame 54 is located at one of the open ends 72 and the second frame 56 is located at the opposite open end 72. Once the battery subassembly 58 is received within the outer cover 60, the sealing bars 62 of the first frame 54 and the second frame 56 are arranged to seal gaps between adjacent battery cells 24 and gaps between the battery cells 24 and the sides 70 of the outer cover 60. The open ends 72 are therefore filled by the battery cells 24, the sealing bars 62, and the remaining portions of the first and second frames 54, 56 such that an interior volume of the battery module 22 is sealed relative to the exterior environment surrounding the battery module 22.

The inlet tube 46 and the outlet tube 48 may extend in parallel with the sealing bars 62. The inlet tube 46 may be attached to one of the sides 70 of the outer cover 60 (here, at the top side of the outer cover 60). The outlet tube 48 may be attached to another one of the sides 70 (here, at the bottom side of the outer cover 60). However, other configurations are contemplated within the scope of this disclosure.

The interior volume 74 of the battery module 22 of FIGS. 3 and 4 is schematically illustrated in FIG. 5. A primary cooling path P1 of the primary cooling system 34 of the thermal management system 32 may extend through the interior volume 74 for cooling the battery cells 24 of the battery module 22. The first cooling fluid F1 may flow over the major surfaces of each battery cell 24 of the battery module 22 as it is circulated along the primary cooling path P1 for providing increased cooling performance.

An interior volume 76 of the traction battery pack 18 is schematically illustrated in FIG. 6. A secondary cooling path P2 of the secondary cooling system 36 of the thermal management system 32 may extend through the interior volume 76 for cooling components such as the terminals 64, the internal busbars 66, and the external busbars 68. The second cooling fluid F2 may be introduced into the interior volume 76 for cooling these and/or other internal battery components.

The secondary cooling system 36 may be configured to automatically introduce the second cooling fluid F2 into the interior volume 76 for flowing along the secondary cooling path P2 during a battery thermal event. A battery thermal event may occur, for example, during over-charging conditions, over-discharging conditions, or other conditions and can cause one or more of the battery cells 24 to expel battery vent byproducts which may include gases, effluent particles, and/or other vent byproducts.

A temperature sensor 78 may be provided in or near the outlet tube 52 of the enclosure assembly 28. The temperature sensor 78 may be operably connected to a control module 80 of the thermal management system 32 and may be configured to sense the temperature of the second cooling fluid F2. When the temperature sensed by the temperature sensor 78 exceeds a predefined threshold, the temperature sensor 78 may provide an input signal to the control module 80. In response to receiving the input signal, the control module 80 may command the secondary cooling system 36 to begin circulating the second cooling fluid F2 through the interior volume 76 along the second cooling path P2 in order to limit thermal propagation during the battery thermal event.

The exemplary traction battery packs of this disclosure include a thermal management system having both a primary cooling system and a secondary cooling system. The primary cooling system may provide a compartmentalized/modularized design with internal coolant flow to maximize heat transfer from battery surfaces to coolant, and the secondary cooling system may provide a pack-level design with cooling fluid flow for maximizing heat transfer from battery terminals and/or internal/external busbars to the cooling fluid.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly;
a plurality of battery modules housed within the enclosure assembly;
a primary cooling system configured for directing a first cooling fluid through a first interior volume of each of the plurality of battery modules; and
a secondary cooling system configured for directing a second cooling fluid through a second interior volume of the enclosure assembly.

2. The traction battery pack as recited in claim 1, wherein each of the plurality of battery modules includes a battery subassembly and an outer cover.

3. The traction battery pack as recited in claim 2, wherein the battery subassembly includes a plurality of battery cells held between a first frame and a second frame.

4. The traction battery pack as recited in claim 3, wherein adjacent battery cells of the plurality of battery cells are at least partially separated by a sealing bar of the first frame and the second frame.

5. The traction battery pack as recited in claim 3, wherein the outer cover includes four sides and two open ends.

6. The traction battery pack as recited in claim 5, wherein the first frame is positioned at one of the two open ends of the outer cover, and the second frame is positioned at another of the two open ends.

7. The traction battery pack as recited in claim 3, wherein the first cooling fluid cools the plurality of battery cells, and the second cooling fluid cools a busbar or a terminal located external to the first interior volume.

8. The traction battery pack as recited in claim 1, wherein the first cooling fluid cools at least one battery cell of each of the plurality of battery modules, and the second cooling fluid cools a busbar or a terminal of each of the plurality of battery modules.

9. The traction battery pack as recited in claim 1, wherein the primary cooling system includes an inlet pipe, a delivering line fluidly connected to the inlet pipe and to an inlet tube of at least one of the plurality of battery modules, an outlet pipe, and a receiving line fluidly connect to an outlet tube of the at least one of the plurality of battery modules and to the outlet pipe.

10. The traction battery pack as recited in claim 9, wherein the first interior volume is located between the inlet tube and the outlet tube.

11. The traction battery pack as recited in claim 1, wherein the secondary cooling system includes an inlet tube mounted to a first end wall of the enclosure assembly, and an outlet tube mounted to a second end wall of the enclosure assembly, and further wherein the second interior volume is located between the inlet tube and the outlet tube.

12. The traction battery pack as recited in claim 1, wherein the first cooling fluid is a coolant, and the second cooling fluid is an airflow or a dielectric fluid.

13. A traction battery pack, comprising:
a battery module including a battery cell, a terminal, and a busbar; and
a thermal management system that establishes a primary cooling path for thermally managing the battery cell and a secondary cooling path for thermally managing the terminal and the busbar.

14. The traction battery pack as recited in claim 13, wherein the primary cooling path extends through an interior volume of the battery module.

15. The traction battery pack as recited in claim 13, wherein the primary cooling path extends between the battery cell and a second battery cell and further between the battery cell and an outer cover of the battery module.

16. The traction battery pack as recited in claim 15, wherein a sealing bar of a frame of the battery module at least partially separates the battery cell from the second battery cell.

17. The traction battery pack as recited in claim 13, wherein the secondary cooling path extends through an interior volume of an enclosure assembly that houses the battery module.

18. The traction battery pack as recited in claim 13, wherein the primary cooling path is configured to circulate a first cooling fluid through portions of an inlet pipe, a delivering line fluidly connected to the inlet pipe, an inlet tube of the battery module that is fluidly connected to the delivering line, an interior volume of the battery module, an outlet tube of the battery module, a receiving line fluidly connected to the outlet tube, and an outlet pipe fluidly connected to the receiving line.

19. The traction battery pack as recited in claim 13, wherein the secondary cooling path is configured to circulate a second cooling fluid through a channel located between the battery module and a second battery module.

20. The traction battery pack as recited in claim 19, wherein the second cooling fluid includes a dielectric fluid or an airflow.
